(19) United States
(12) Patent Application Publication
(10) Pub. No.: US 2019/0350401 A1
(43) Pub. Date: Nov. 21, 2019

(54) PREPARATION DEVICE FOR EXTRACTION BEVERAGES AND LIFTING DEVICE FOR STRAINERS

(71) Applicant: Carrera Brands Limited, Kowloon Bay (HK)

(72) Inventor: Dirk Hagen Zimmermann, Dusseldorf (DE)

(21) Appl. No.: 16/413,981

(22) Filed: May 16, 2019

(30) Foreign Application Priority Data
May 18, 2018 (EP) 18 173 326.2

(51) Int. Cl. A47J 31/20; A47J 31/44; A47J 31/06

(52) U.S. Cl. CPC A47J 31/20; A47J 31/0615; A47J 31/446

(57) ABSTRACT

The present disclosure relates to a lifting device for a strainer for preparing extraction beverages, particularly a tea strainer, which comprises a timer, a spring for generating a lifting force on the strainer, a latch which can be moved between a first latch position and a second latch position, and a magnet. The latch keeps the spring tensioned in the first latch position and allows relaxation of the spring in the second latch position. The magnet is configured to move the latch by magnetic interaction from the first latch position into the second latch position when the timer is in a zero position. The disclosure further relates to a device for preparing extraction beverages, particularly a tea maker, which comprises a housing, a space for receiving water, a strainer, which can be moved between a first strainer position, in which the strainer is located in said space, and a second strainer position, and such a lifting device. The lifting device keeps the strainer in the first strainer position in the first latch position and allows movement of the strainer into the second strainer position in the second latch position.

### PRIORITY

This application claims priority to European Patent Application No. 18 173 326.2, entitled “Preparation Device For Extraction Beverages And Lifting Device For Strainers,” filed May 18, 2018, the disclosure of which is incorporated by reference herein.

### FIELD OF THE INVENTION

This invention relates to the field of devices for preparing extraction beverages, particularly tea makers, and lifting devices for a strainer for preparing extraction beverages.

### BACKGROUND OF THE INVENTION

Extraction beverages, such as tea or coffee, can be prepared by exposing an extraction material based on plant parts to hot water for a specific period of time. The plant parts may include, for example, tea leaves or ground coffee beans. The extraction material is typically located in a strainer during the brewing process, such that it can come into contact with the water for extraction and be removed from the water upon completion of the brewing process.

Various components of the plant parts are extracted in the course of the brewing process. For example, bitter substances can decisively influence the taste of the tea. The period of time the extraction material is exposed to the water (infusion time) has an influence on the composition of the resulting extraction beverage. In order to prepare a beverage of constant quality and taste, the infusion time should be substantially the same in each brewing process. A brewing time is particularly selected for controlling the extraction of desired components while minimizing the extraction of undesirable components from the plant parts.

But the desired brewing time may differ depending on the type of the extraction material. For example, herbal teas are often brewed for 5-10 minutes, whereas black teas are often brewed for just 1-3 minutes.

The preparation wishes can also change depending on the consumer of the extraction beverage. Some consumers prefer a “strong” tea (long infusion time), while others prefer a tea with a shorter infusion time.

Devices for measuring infusion times and for interrupting the brewing process of extraction beverages after a predetermined time are known from prior art. These devices have a number of disadvantages. These include complicated or error-prone manufacture, difficult or error-prone operation, unreliable triggering of the interruption, large size, need for an external power supply.

In this context, in view of these and other disadvantages, it is the problem of the present invention to provide an improved device for preparing extraction beverages, particularly devices for setting the infusion time and for ending the brewing process.

### DESCRIPTION OF THE INVENTION

This problem is solved by devices according to the independent patent claims, particularly by a lifting device for a strainer and a preparation device with a strainer and such a lifting device. The dependent claims describe preferred embodiments.

In a first aspect, the present invention relates to a device for preparing extraction beverages, hereinafter called preparation device. A preparation device according to the invention includes a housing, a strainer, and a lifting device for lifting the strainer. The preparation device may particularly be a tea maker with a tea strainer or a coffee maker with a coffee strainer.

The housing encloses a space for receiving water. The strainer can be moved between a first strainer position and a second strainer position. At any rate, said first strainer position is inside the space for receiving water.

In operation, the strainer can be located in the first strainer position during the brewing process, such that extraction material located in the strainer comes into contact with the water. When the brewing process is completed, the strainer can be moved into the second strainer position. The second strainer position can be inside or outside of said space for receiving water. The second strainer position is preferably predetermined such that the strainer—if the preparation device is properly filled with water—is not in contact with the water.

The lifting device is a lifting device according to the invention having a latch, wherein, in a first latch position, said lifting device keeps the strainer in the first strainer position and in a second latch position the strainer can move into the second strainer position.

The preparation device can in some embodiments also include means for heating water. In such embodiments, the preparation device is adapted to heat the water to a brewing temperature, particularly boiling temperature (100° C.) and to end the brewing process after the infusion time has elapsed. The brewing temperature can either be predetermined or user-selectable. The strainer can be lowered before, upon, or after reaching the brewing temperature. Furthermore, lowering can be manual or automatic.

In another aspect, the present invention relates to a lifting device for a strainer for preparing extraction beverages. A lifting device according to the invention includes a timer, a spring for generating a lifting force applied to the strainer, a latch, and a magnet.

The latch can be moved between a first latch position and a second latch position, wherein it keeps the spring tensioned in the first latch position and allows relaxation of the spring in the second latch position.

The magnet is configured to move the latch by magnetic interaction from the first latch position into the second latch position when the timer is in a zero position. In some embodiments, the device includes an opposite pole with which the magnet can interact to move the latch. The opposite pole can preferably be configured as a separate component or integral with another component, particularly the latch.

The timer is adapted to set an infusion time during which the strainer remains in the first strainer position. Infusion time can be preset by the manufacturer or can be set by a user by selecting a desired infusion time. The timer may preferably be a mechanical timer or a digital timer. Mechanical timers can either be equipped with a quartz movement or with a gear train and escapement.

In some embodiments, the timer includes a display for indicating the infusion time and/or a display for indicating the remaining infusion time. The display may for example be a digital display or a hand and dial display.

The timer may be used to measure the expiration of the predetermined or desired infusion time from the start of the brewing process When the infusion time has expired, the timer reaches a zero position. In the case of a mechanical timer, the zero position may particularly coincide with a hand position at “0” on the dial.

The lifting device according to the invention is adapted that, when the timer reaches its zero position, the magnet is caused to move the latch from the first latch position into the second latch position. The latch can particularly be a sliding latch which can be moved between the first latch position and the second latch position.

In some embodiments, the latch is biased such that it is in its first latch position if no other forces are applied. This can be achieved by means of a latch spring, which applies a latch spring force towards the first latch position to the latch. In such embodiments, magnetic interaction must overcome the latch spring force before the latch can move into the second latch position. The latch spring may for example be a coil spring, particularly a compression coil spring or a tension coil spring.

In general, the magnet is used to generate a magnetic field in its environment to engage in an attracting or repelling interaction with another body. Such interaction is a magnetic, particularly a ferromagnetic interaction. The magnet may be a permanent magnet or an electromagnet, for example.

A permanent magnet generates a magnetic field in its environment and can be used to engage in an attracting or repelling interaction with another body if such body is in spatial proximity to the permanent magnet.

An electromagnet generates a magnetic field in its environment if an electric current flows through it. For example, an electromagnet may include a coil and a soft iron core. An electromagnet can therefore be used to engage in an attracting or repelling interaction with another body as soon as an electric current flows through it.

Particularly, the other body may be another permanent magnet or it may be a body which interacts with a magnet, e.g. due to its ferromagnetic properties, without generating a magnetic field itself. Particularly, the other body may include a metal, e.g. iron, cobalt, or nickel, or a metallic alloy.

If the other body is another magnet, the interaction can be attracting (in that different magnetic poles are facing each other) or repelling (in that same magnetic poles are facing each other).

For the purposes of describing the present invention, another body which interacts with the magnet will be called an opposing pole, regardless of whether it is another permanent magnet or a body without a permanent magnetic field and regardless of whether the interaction with the magnet is attracting or repelling.

The magnet in a lifting device according to the invention is configured to move the latch by magnetic interaction from the first latch position into the second latch position.

This can particularly be achieved in that the lifting device includes an opposite pole. The magnet may for example be disposed on the latch or on the timer. The opposite pole can be disposed on the other of these two parts. In some embodiments in which the magnet is disposed on the latch, the opposite pole may be disposed on the timer. In some embodiments in which the magnet is disposed on the timer, the opposite pole may be disposed on the latch. For the purposes of describing the present invention, an object (magnet, opposite pole) being disposed “on” a component (latch, timer) means that these are at least mechanically connected or in contact with each other. For example, the object can be enclosed or surrounded by the component, or it can be integral with the component.

The latch can therefore be moved due to magnetic interaction. In some embodiments, magnetic interaction between the magnet and the opposing pole may be attracting, such that the latch is moved towards the timer into the second latch position. Alternatively, the magnetic interaction can be repelling, such that the latch is moved away from the timer into the second latch position.

Magnetic interaction can be triggered in various ways, particularly by a relative movement of (permanent) magnet and opposite pole and/or by switching on the electromagnet.

For example, magnetic interaction can be caused in that an opposite pole is brought into spatial proximity to the magnet, preferably a permanent magnet (or vice versa the magnet is brought into spatial proximity to the opposite pole). To this end, the opposite pole (or the magnet) may in some embodiments be disposed on the timer in such a manner that it is moved along a perimeter of the timer while the infusion time is running and is in spatial proximity to the magnet (or the opposite pole) when the timer is in a zero position. Such an arrangement is preferred in embodiments with mechanical timers which comprise mechanical parts that move while the infusion time is running Alternatively, embodiments with digital times may comprise a mechanism which causes a movement of the opposite pole (or magnet) when the infusion time expires.

Alternatively, or in addition, magnetic interaction can be caused by switching on an electromagnet. In such embodiments, the opposite pole may be in permanent spatial proximity to the magnet. Such an arrangement is preferred in embodiments with digital timers which output an electric signal when the infusion time has expired, which signal can be used for switching on the electromagnet. Alternatively, embodiments with mechanical times may comprise a mechanism which causes switching on the electromagnet when the infusion time expires.

In the second latch position, the latch allows relaxation of the spring. In the course of such relaxation, the spring can apply a lifting force to the strainer and in this way lift the strainer from the first strainer position into the second strainer position. The configuration of the spring preferably ensures a lifting force that a strainer filled with extraction material is lifted far enough that it is not in contact with water—when the preparation device is properly filled with water.

In some embodiments, the spring may include a compression coil spring, which can be compressed to bring the strainer into the first strainer position and will cause movement of the strainer into the second strainer position when it relaxes. Such a spring is compressed and under tension in the first strainer position. In the second strainer position, the spring is substantially relaxed or at least less tensioned than in the first strainer position.

In some embodiments, the spring may include a tension coil spring, which can be expanded to bring the strainer into the first strainer position and will cause movement of the strainer into the second strainer position when it relaxes. Such a spring is expanded and under tension in the first strainer position. In the second strainer position, the spring is substantially relaxed or at least less tensioned than in the first strainer position.

The first strainer position corresponds to a brewing position, which is taken for the duration of the brewing process. The second strainer position corresponds to a lifting position, which is taken when the brewing process is completed.

In some embodiments, the lifting device includes a trigger device which is adapted to move the latch from the first latch position into the second latch position, whether the timer is in zero position or not. The trigger device may for example include a pushbutton which is connected to the latch such that operation of the pushbutton results in a compression force being applied to the latch, which causes movement of the latch from the first latch position into the second latch position.

### BRIEF DESCRIPTION OF THE FIGURES

In the following description of exemplary embodiments of the invention, reference is made to the enclosed drawings, wherein:

FIG. 1A is a schematic view of an embodiment of a preparation device in brewing position, with the tea strainer in a first strainer position;

FIG. 1B shows a schematic view of the preparation device of FIG. 1A in the lifting position, with the tea strainer in a second strainer position;

FIG. 2A shows a schematic view of a strainer with a lifting device according to one embodiment, in a first strainer position;

FIG. 2B shows a schematic view of a strainer with a lifting device according to FIG. 2A, in a second strainer position;

FIG. 3A shows a cross sectional view of a strainer with a lifting device according to one embodiment, in a first strainer position;

FIG. 3B shows a cross sectional view of a strainer with a lifting device according to FIG. 3A, in a second strainer position;

FIG. 4 shows an exploded view of a strainer with a lifting device according to one embodiment;

FIGS. 5A to 5D show cross sections of a lifting device according to one embodiment in a sequence of states during operation;

FIG. 6 shows a cross sectional view of a strainer with a lifting device according to another embodiment;

FIG. 7 shows a cross sectional view of a strainer with a lifting device according to another embodiment;

FIG. 8A shows a cross sectional view of a strainer with a lifting device according to another embodiment, in a first strainer position;

FIG. 8B shows a cross sectional view of a strainer with a lifting device according to FIG. 8A, in a second strainer position;

FIG. 9 shows an exploded view of a strainer with a lifting device according to one embodiment.

### DESCRIPTION OF EXEMPLARY EMBODIMENTS

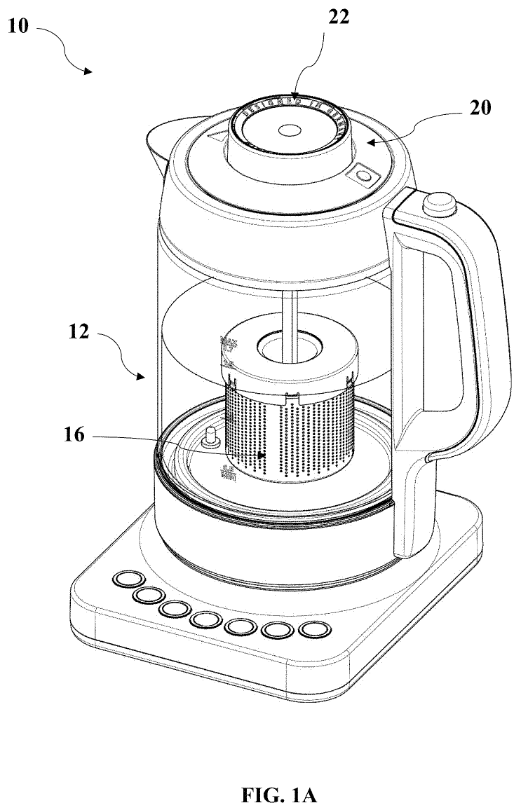

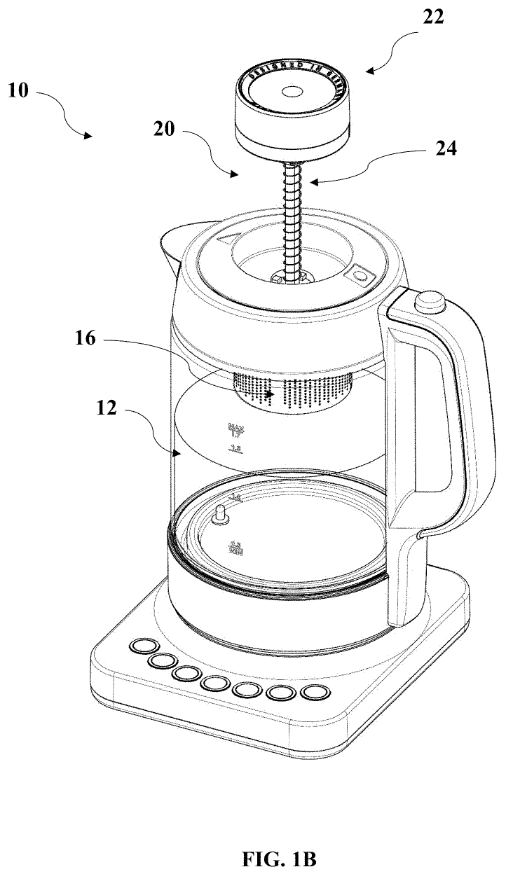

FIG. 1A shows a tea maker 10 in brewing position. The tea maker 10 includes a housing 12 and a tea strainer 16. The housing encloses a space for receiving water. In FIG. 1A, the tea strainer 16 is in a first strainer position, inside the space for receiving water, such that it is in contact with the water when the space is filled. In this brewing position, tea can be prepared from tea leaves which were filled into the tea strainer before operating the tea maker.

The tea maker 10 further includes a lifting device 20 for lifting the strainer. The lifting device 20 comprises a mechanical timer 22 for setting a desired infusion time.

The timer 22 can be operated similar to an egg timer. A desired infusion time can be set by rotating the timer 22 relative to the remaining components of the lifting device 20. The timer comprises a dial from which the set period of time can be read by means of a hand. The timer starts measuring the time as soon as a period has been set (for example by letting go of the rotated component). While the time is running, the dial and hand show the remaining run time. When the time has expired, the lifting device lifts the tea strainer from the first strainer position into a second strainer position. The tea maker is then in the lifted position.

FIG. 1B shows the tea maker 10 of FIG. 1A in the lifted position. The lifting device 20 was triggered, such that the spring 24 has lifted the strainer 16 into the second strainer position. This second strainer position is in the case shown inside the space enclosed by the housing 12, but higher than the first strainer position. This ensures that—even if the tea maker 10 is filled to the maximum level with water—the strainer 16 is above the water surface. Tea leaves in the strainer are thus no longer in contact with the water. Preparation of the tea is completed or at least interrupted. The timer 22 was lifted together with the strainer 16.

If the user would like to continue the extraction, the lifting device 20 can be returned to the brewing position shown in FIG. 1A by applying force against the spring 24 and setting a remaining infusion time.

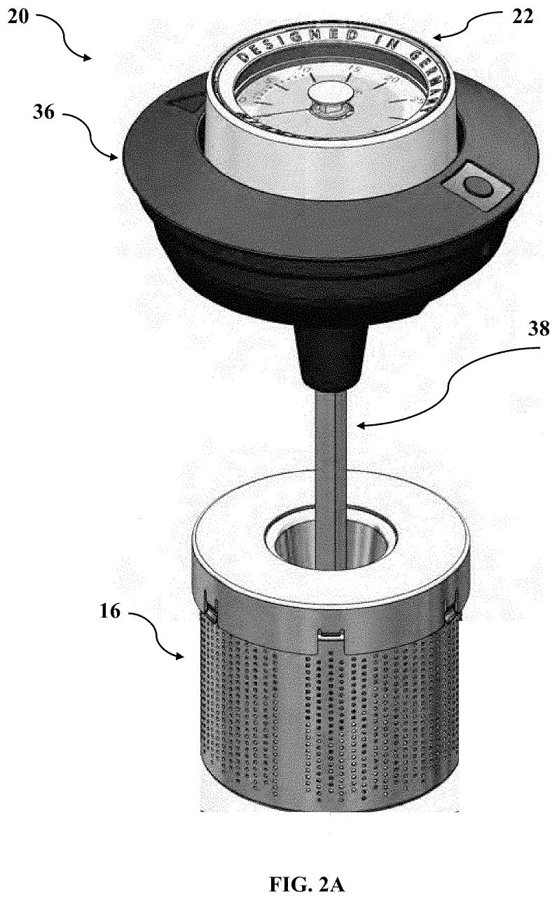

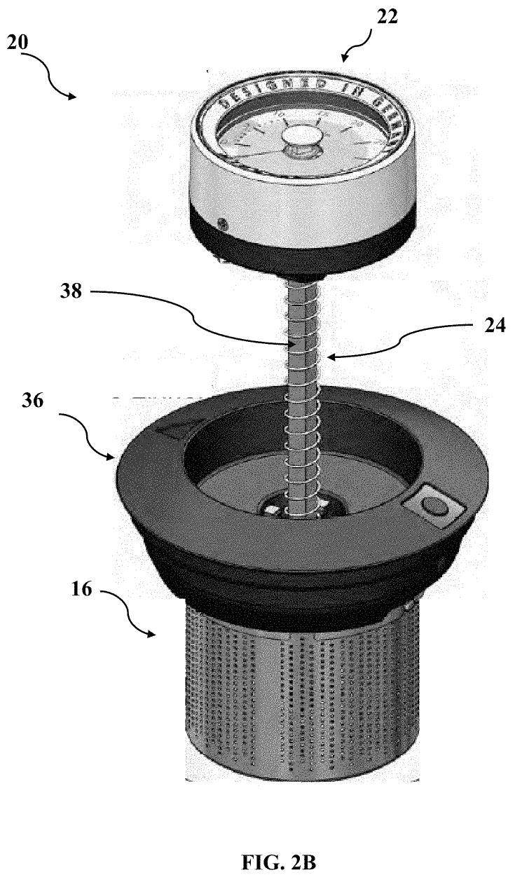

FIG. 2A shows a schematic view of a strainer 16 with a lifting device 20 in a first strainer position. The first strainer position corresponds to the arrangement during the brewing process, for example like in the tea maker 10 in brewing position according to FIG. 1A.

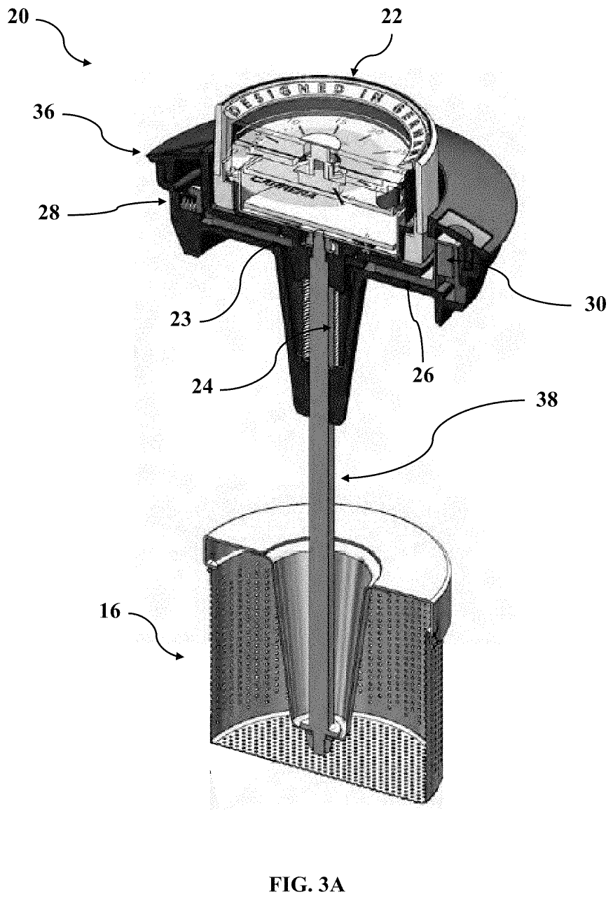

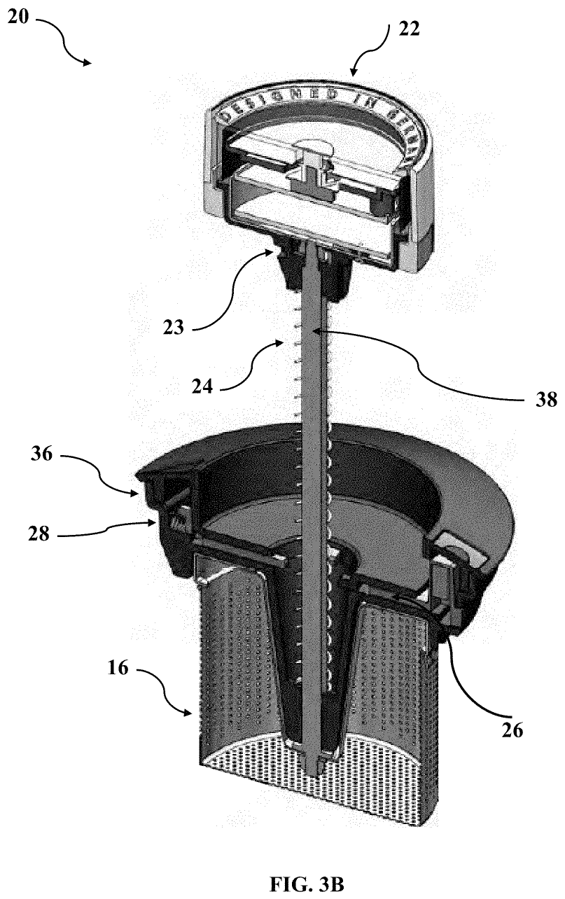

The lifting device 20 includes a timer 22, a spring (not visible) for generating a lifting force applied to the strainer, a latch (not visible), and a magnet (not visible), as described below, particularly with reference to FIGS. 3A and 3B.

The lifting device 20 further includes a frame 36 for fastening the lifting device to a tea maker. The frame 36 may particularly be inserted in a lid or lid recess of the tea maker, as shown in FIG. 1A. The lifting device 20 further includes a guide bar 38 for guiding the spring along an axis. The guide bar is connected to the timer 22 on the one hand and to the strainer 16 on the other. Its length, together with the configuration of the spring, determines the lift of the lifting device and thus the distance between the first strainer position and the second strainer position.

FIG. 2B shows the strainer 16 and the lifting device 20 according to FIG. 2A in the second strainer position. The second strainer position corresponds to the arrangement after completing the brewing process, for example like in the tea maker 10 in lifted position according to FIG. 1B. The strainer 16 is now arranged closer to the frame 36, which may for example be connected to a lid of the tea maker, as shown in FIG. 1B.

The lifting device 20 comprises a spring 24, which is configured as a compression coil spring which is wrapped around the guide bar 38. The guide bar 38 thus guides the spring 24. The spring 24 rests against the timer 22 and the frame 36. In the compressed state of the spring (FIG. 2A), the timer 22 and the frame 36 can thus be in spatial proximity to each other.

In FIG. 2B, the spring 24 is shown in an elongate, substantially relaxed state. In this substantially relaxed state, the spring 24 keeps the timer 22 at a spacing to the frame 36. The fixed connection between timer 22 and strainer 16 by means of the guide bar 38 causes the strainer to be lifted simultaneously with the timer. The spring 24 thus applies a lifting force to the timer 22 and the strainer 16.

The lifting device 20 of FIGS. 2A and 2B thus causes lifting of the strainer by means of the lifting force of the spring 24. The triggering of the lifting force by relaxing the spring 24 is caused by means of a latch in the lifting device 20, as described below with reference to FIGS. 3A and 3B.

FIG. 3A shows a cross section of a strainer 16 with a lifting device 20 in a first strainer position. The lifting device 20 comprises a compression coil spring 24, which is shown in its compressed, tensioned state in FIG. 3A. The spring 24 on the one hand rests against the frame 36 of the lifting device, on the other hand it rests against the timer 22 of the lifting device. It is wrapped around a guide bar 38, which serves as a guide for the spring 24 and connects the timer 22 to the strainer 16.

The lifting device 20 in addition comprises a latch 26, which prevents the spring 24 from relaxing. To this end, the latch 26 is in a first latch position. In the case shown, it is characterized in that a portion of the latch comes into engagement with a groove 23 of the timer. The latch 26 keeps the spring 24 tensioned and thus prevents movement of the timer 22 and the strainer 16 relative to the other components of the lifting device, particularly the frame 36. The strainer 16 is kept in the first strainer position despite the compressed (tensioned) compression spring due to the engagement of the latch 26.

The latch 26 includes a latch spring 28, which keeps the latch in said first latch position. The latch spring 28 ensures that the portion of the latch mentioned and the groove 23 remain engaged and are not detached from each other (e.g. due to shocks).

FIG. 3B shows a cross section of the strainer 16 with the lifting device 20 according to FIG. 3A, wherein the strainer is in a second strainer position. Unlike FIG. 3A, the latch 26 and the groove 23 of the timer are no longer in engagement.

The spring 24 is thus substantially tensioned and (supported by the guide bar 38) keeps the timer 22 and frame 36 apart. The fixed connection of the strainer 16 with the timer 22 at the same time results in lifting of the strainer 16 towards the frame 36.

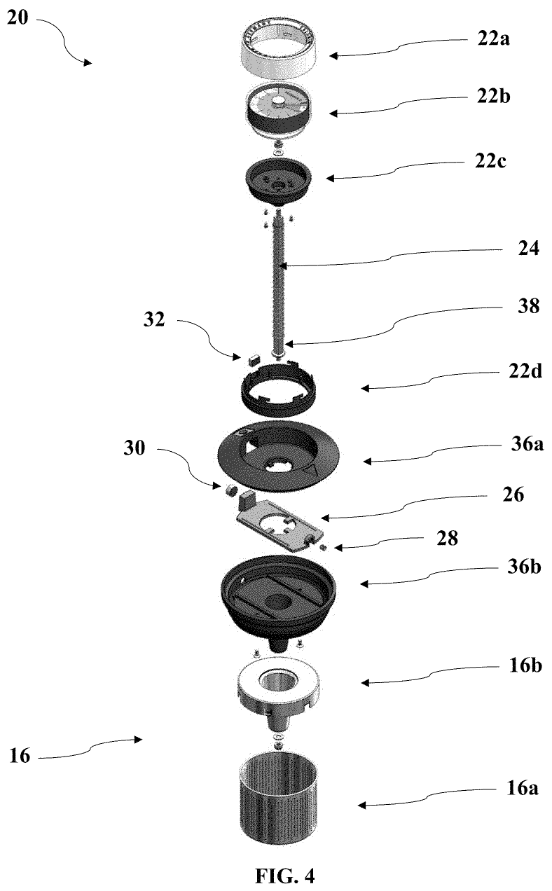

FIG. 4 shows an exploded view of a strainer 16 with a lifting device 20, which substantially matches the embodiments of FIGS. 2A-3B.

The strainer 16 includes a perforated strainer wall 16a, which encloses a space for receiving the tea leaves, and a strainer lid 16b. The strainer lid 16b and the strainer wall 16a are detachably connected for filling the strainer with tea leaves or for cleaning the strainer.

The lifting device 20 includes a timer 22, a spring 24 disposed around a guide bar 38, a latch 26, and a permanent magnet 30.

The timer is a mechanical timer with a display for indicating the remaining run time by means of a hand and a dial. It includes a rotary knob top 22a, clock timer 22b, timer housing 22c, and rotary knob bottom 22d. The rotary knob top 22a and rotary knob bottom 22d form a rotary knob. The desired infusion time can be set by rotating the rotary knob. While the infusion time is running, the movable parts of the timer move back to a zero position. The timer can be used to measure the desired infusion time from the beginning of the brewing process. When the infusion time expires, the timer reaches the zero position, herein shown as “0” on the dial.

The magnet 30 is configured to move the latch 26 by magnetic interaction from the first latch position into the second latch position when the timer is in the zero position. In the case shown, the magnet is a permanent magnet 30 which is disposed on the latch 26 and constantly generates a magnetic field in its environment to enter into attracting interaction with an opposite pole 32.

The opposite pole 32 can either be configured as another permanent magnet or made of another ferromagnetic material and is disposed on the timer 22 in the rotary knob bottom 22d. This opposite pole 32 is moved away from the magnet 30 when the rotary knob is turned to set the infusion time, and while the infusion time is running it moves together with the rotary knob bottom 22d. The magnet 30 and the opposite pole 32 are arranged such that they are in immediate proximity to each other and enter into attracting interaction when the timer 22 is at the zero position.

In the case shown, the magnet 30 is provided a s a separate component, in addition to the latch 26, which is made of a plastic material here. In other embodiments, a magnet may instead be configured integral with the latch, e.g. by magnetizing a portion of the metallic latch. This applies accordingly to the opposite pole.

The latch 26 is a sliding latch, which can be moved between the first latch position and the second latch position. It is held in the first latch position by a latch spring 28, which applies a latch spring force to the latch 26 in the first latch position. The latch comprises multiple protrusions, one of which may come into engagement with one or multiple grooves (not visible) in the timer.

The latch 26 can be moved towards the timer 22 into the second latch position due to the attracting magnetic interaction between the magnet 30 and the opposite pole 32. The magnetic interaction is caused by bringing the opposite pole 32 into spatial proximity to the permanent magnet 30. To this end, the opposite pole 32 is disposed on the rotary knob bottom 22d in such a manner that it is moved along the perimeter of the timer 22 while the infusion time is running and is in spatial proximity to the magnet 30 when the timer 22 is in a zero position. In this arrangement, different magnetic poles of the permanent magnet 30 and the opposite pole 32 are facing each other, such that the interaction is attracting.

The latch 26 is encompassed by a frame with a frame top 36 a and a frame bottom 36b. The frame, in the case shown the frame bottom 36b, also serves as a contact point of the spring 24.

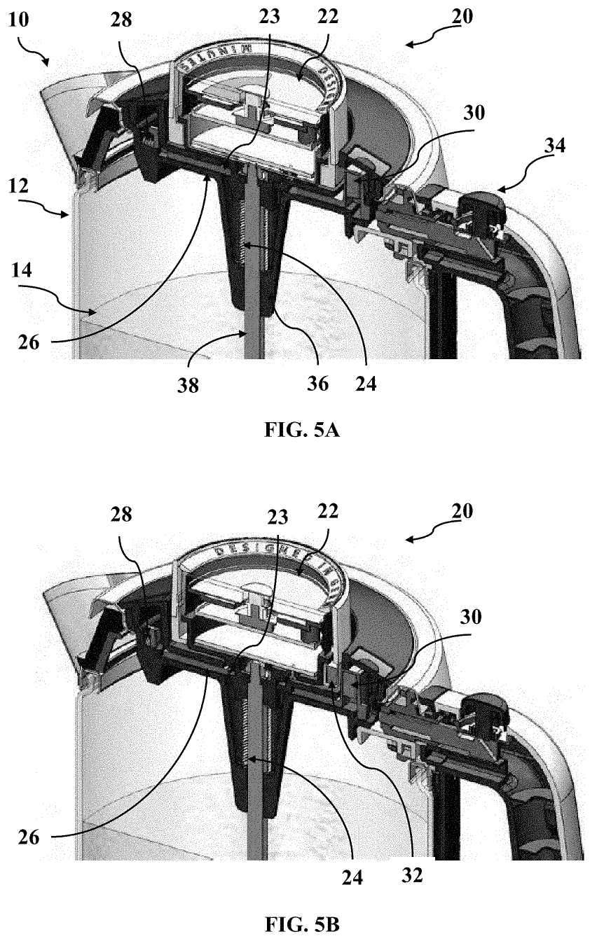

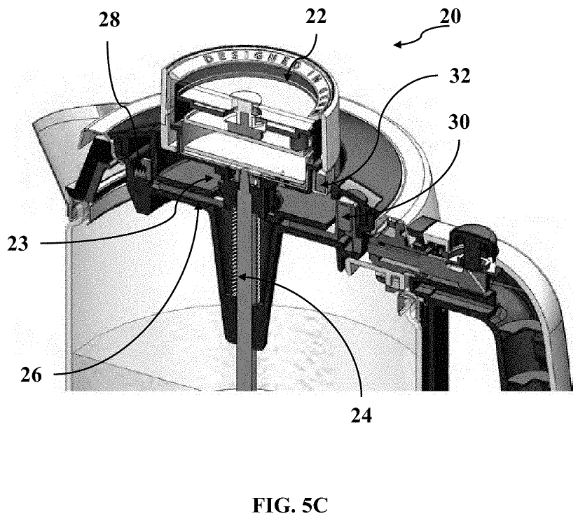

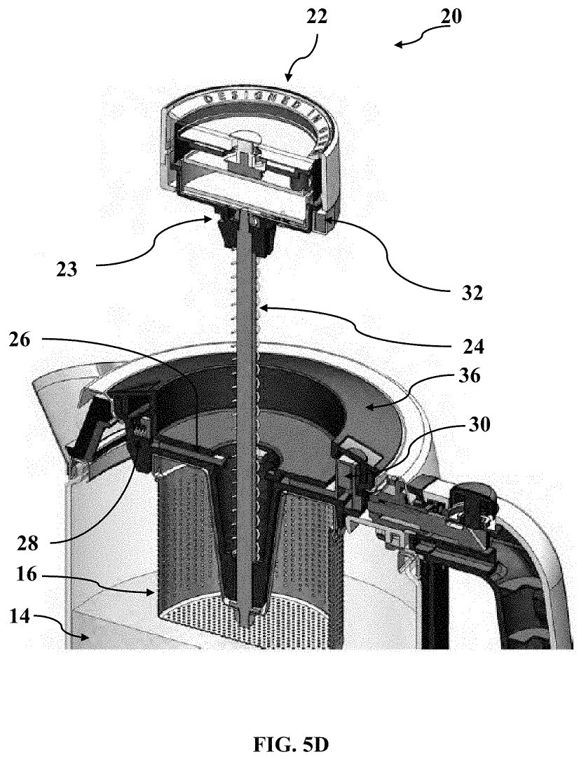

FIG. 5A to 5D show cross sections of a lifting device 20 according to FIG. 4 in a sequence of states during operation. The lifting device 20—as explained above—includes a timer 22, a spring 24 disposed around a guide bar 38, a latch 26, and a permanent magnet 30.

FIG. 5A shows the lifting device 20 during the brewing process in a tea maker 10 having a housing 12 and a space 14 for receiving water, which space is enclosed by the housing and shortly called ‘inner space’. The strainer (not shown) is in a first strainer position inside the inner space in contact with the water which is present in the inner space. The latch 26 is in a first latch position, such that a portion of the latch 26 comes into engagement with a groove 23 of the timer 22. The latch 26 thus prevents the spring 24, which is mounted between the frame 36 and the timer 22, from relaxing.

The latch 26 includes a latch spring 28, which keeps the latch in said first latch position. The latch spring 28 ensures that the portion of the latch mentioned and the groove 23 remain engaged and are not detached from each other—e.g. due to shocks.

FIG. 5A further shows a trigger device 34 in the form of a pushbutton. The pushbutton is connected to the latch such that operation of the pushbutton results in a compression force being applied to the latch, which causes movement of the latch from the first latch position into the second latch position. The pushbutton 34 is adapted to move the latch 26 from the first latch position into the second latch position, whether the timer is in zero position or not. This allows manual abortion of the brewing process before the infusion time ends.

Furthermore, the manual trigger device facilitates manual operation. To this end, the infusion time may for example be set to “indefinite”. In this operating mode, the zero position of the timer is reached and the lifting device will not be triggered by the magnet. Nevertheless, a user can stop the brewing process manually at any time by pressing the pushbutton 34, for example when such user has checked the color of the tea by visual inspection or determined the desired quality of the tea by checking its taste.

FIG. 5B shows the lifting device 20 at the end of the brewing process. The opposite pole 32 was moved along the perimeter of the timer 22 during the infusion time. In the zero position of the timer 20 shown (after the infusion time has expired), the opposite pole 32 is in direct proximity to the permanent magnet 30 which is disposed on the latch 26. This causes an attracting magnetic interaction between the permanent magnet 30 and the opposite pole 32. This interaction moves the latch 26 from the first latch position against the compressive force of the latch spring 28 towards the second latch position. When reaching the second latch position, the engagement of the latch 26 and the groove 23 of the timer 22 is released. Relaxation of the spring 24 is imminent.

FIG. 5C shows the lifting device 20 at a moment during the relaxation of the spring 24. The groove 23 of the timer 22 was lifted—together with the timer as a whole—by the lifting force of the spring 24 relative to the latch 26 and the frame. A strainer connected to the timer by the guide bar is lifted as well.

FIG. 5D shows the lifting device 20 with the strainer 16 in the second strainer position, i.e. after completion of the brewing process and the lifting process. The spring 24 is substantially relaxed. This keeps the timer 22 at a distance from the frame 36. By lifting the timer 22 and if there is a rigid connection between the strainer 16 and the timer 22 by means of the guide bar, the strainer 16 was also lifted into a second strainer position, in which it is still located in the inner space 14 but not in contact with the water.

The latch 26 was returned to the first latch position by the latch spring 28, such that pressing the timer 22 and strainer 16 back down into the first strainer position results in renewed engagement of the latch 26 and the groove 23. The timer 22 has a beveled guide flank for the latch 26 adjacent to the groove 23 for this purpose. The portion of the latch 26 that comes into engagement may also be beveled to facilitate engagement. For example, the brewing process can be continued, or the device can be stored in a compact form after a cleaning.

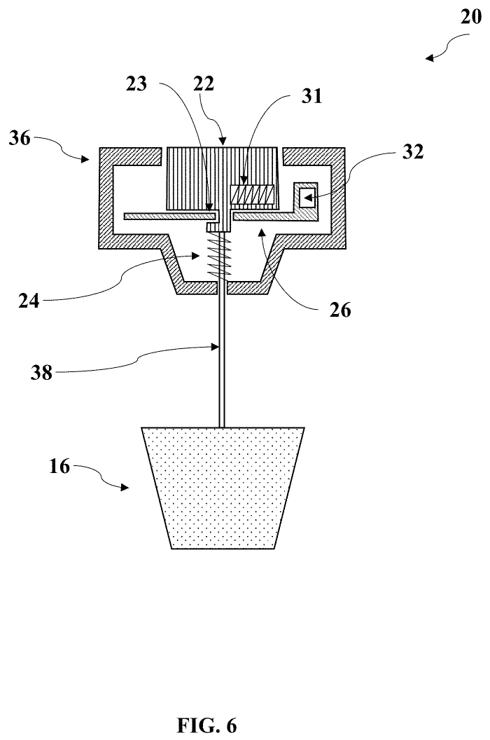

FIG. 6 shows a cross section of a strainer 16 with a lifting device 20 according to another embodiment. Like the embodiments described above, the lifting device 20 comprises a timer 22, a spring 24, a latch 26, a frame 36, and a guide bar 38. Unlike the embodiments described with reference to the preceding figures, the timer 22 is a digital timer. The lifting device 20 also comprises an electromagnet 31, which is disposed on the timer 22, and an opposite pole 32, which is disposed on the latch 26. The opposite pole 32 is in immediate proximity to the magnet.

When the time set on the digital timer 22 runs out, the electromagnet 31 is switched on, and a magnetic field is generated. The digital timer 22 outputs an electric signal when the infusion time expires, which signal is used for switching on the electromagnet 31. This causes an attracting force of the electromagnet to act on the opposite pole 32. The attraction results in movement of the latch 26, thereby releasing the engagement of the latch in the groove 23 of the timer 22. Like in the embodiments described above, this results in a lifting force being applied to the strainer.

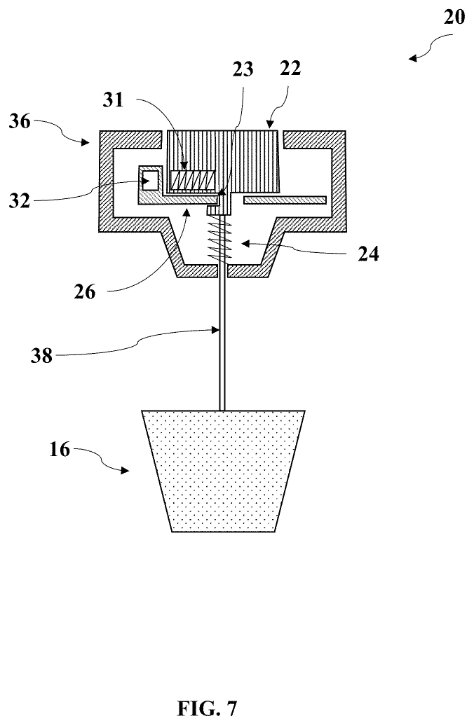

FIG. 7 shows a cross section of a strainer 16 with a lifting device 20 according to another embodiment. This substantially corresponds to the embodiment of FIG. 6 , however—unlike FIG. 6—the groove 23 of the timer, which is in engagement with the latch 26, is located on the same side as the arrangement of magnet 31 and opposite pole 32.

Accordingly, the magnet 31 and the opposite pole 32 are configured for a repelling magnetic interaction (as soon as the electromagnet is switched on). The repelling interaction causes a movement of the latch (to the left in the drawing), such that the engagement of the latch 26 and the groove 23 releases. Like in the embodiments described above, this again results in a lifting force being applied to the strainer.

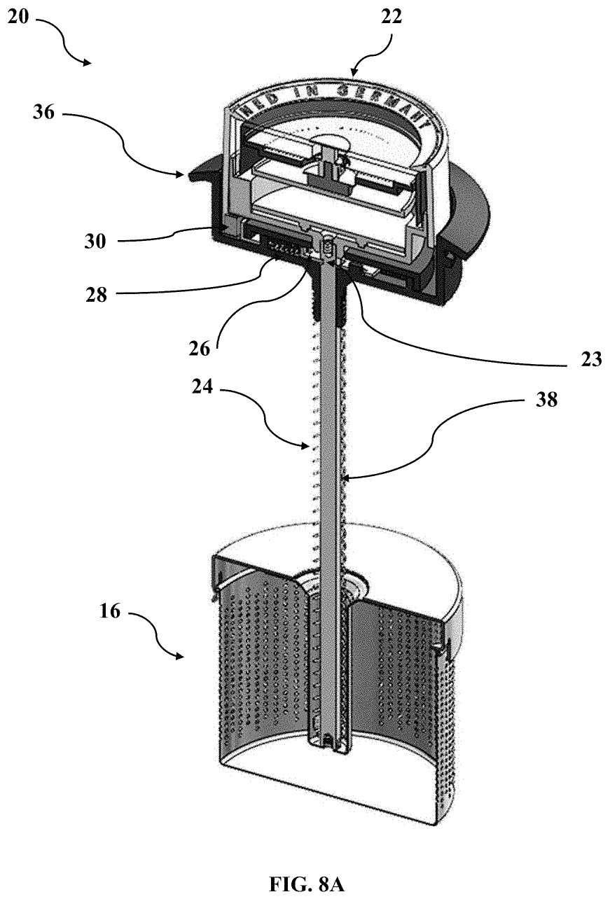

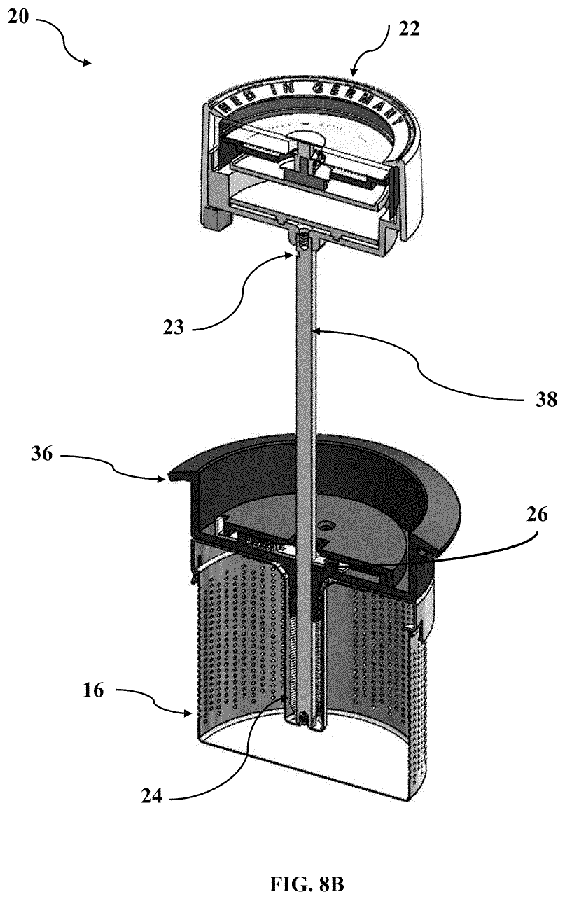

FIG. 8A shows a cross section of a strainer 16 with a lifting device 20 according to another embodiment, in a first strainer position. The lifting device 20 comprises a tension coil spring 24, which is shown in its expanded and tensioned state in FIG. 8A. The spring 24 on the one hand rests against the frame 36 of the lifting device, on the other hand it rests against the timer 16. It is wrapped around a guide bar 38, which serves as a guide for the spring 24 and connects the timer 22 to the strainer 16.

The lifting device 20 in addition comprises a latch 26, which prevents the spring 24 from relaxing. To this end, the latch 26 is in a first latch position. In the case shown, it is characterized in that a portion of the latch comes into engagement with a groove 23 of the guide bar 38. The latch 26 keeps the spring 24 tensioned and thus prevents movement of the guide bar 38 and the strainer 16 attached to it relative to the latch 26 and the frame 36. The strainer 16 is kept in the first strainer position despite the expanded (tensioned) tension spring due to the engagement of the latch 26.

The latch 26 includes a latch spring 28, which keeps the latch in said first latch position. The latch spring 28 ensures that the portion of the latch mentioned and the groove 23 remain engaged and are not detached from each other (e.g. due to shocks).

FIG. 8B shows a cross section of the strainer 16 with the lifting device 20 according to FIG. 8A, wherein the strainer is in a second strainer position. Unlike FIG. 3A, the latch 26 and the groove 23 of the guide bar are no longer in engagement.

The spring 24 has contracted compared to FIG. 8A, is therefore substantially relaxed (or at least less tensioned than in the first strainer position) and keeps the strainer 16 near the frame 36, supported by the guide bar 38. The fixed connection of the strainer 16 with the timer 22 by the guide bar 38 at the same time results in lifting of the timer 22, away from the frame 36.

Relaxation of the tension spring 24 towards its retracted state was made possible in that the latch 26 was brought into the second latch position by magnetic attraction of the magnet 30 when the timer 22 reached the zero position. This released the engagement of the latch 26 and the groove 23 in the guide bar 38, and the tension spring could apply a lifting force to the strainer due to its relaxation.

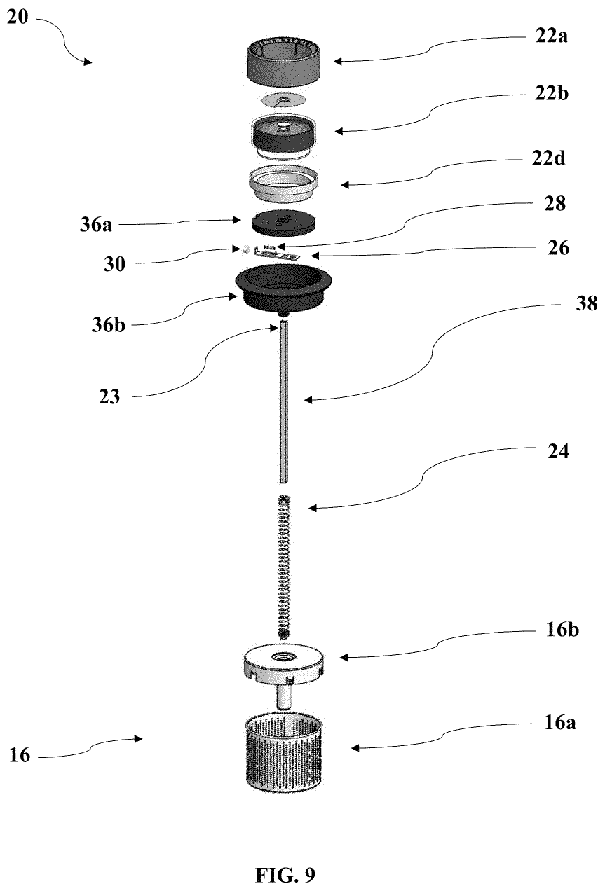

FIG. 9 shows an exploded view of a strainer 16 with a lifting device 20, which substantially matches the embodiment of FIGS. 8A-8B.

The strainer 16 includes a perforated strainer wall 16a, which encloses a space for receiving the tea leaves, and a strainer lid 16b. The strainer lid 16b and the strainer wall 16a are detachably connected for filling the strainer with tea leaves or for cleaning the strainer.

The lifting device 20 includes a timer 22, a latch 26, a permanent magnet 30, and spring 24 disposed around a guide bar 38.

The timer is a mechanical timer and includes a rotary knob top 22a, a clock timer 22b, and a rotary knob bottom 22d. The rotary knob top 22a and rotary knob bottom 22d form a rotary knob. The desired infusion time can be set by rotating the rotary knob. While the infusion time is running, the movable parts of the timer move back to a zero position.

The magnet 30 is configured to move the latch 26 by magnetic interaction from the first latch position into the second latch position when the timer is in the zero position. In the case shown, the magnet is a permanent magnet 30 which is disposed on the rotary knob bottom 22d and constantly generates a magnetic field in its environment to enter into attracting interaction with a latch made of a ferromagnetic material and configured as opposite pole.

The magnet 30 is moved away from the latch 26 which acts as an opposite pole when the rotary knob is turned to set the infusion time, and while the infusion time is running it moves together with the rotary knob bottom 22d. The magnet 30 and the latch 26 are arranged such that they are in immediate proximity to each other and enter into attracting interaction when the timer 22 is at the zero position.

The latch 26 is a sliding latch, which can be moved between the first latch position and the second latch position. It is held in the first latch position by a latch spring 28, which applies a latch spring force to the latch 26 in the first latch position. The latch comprises multiple protrusions, one of which may come into engagement with a groove 23 in the guide bar 38.

The latch 26 can be moved away from the guide bar 38 into the second latch position due to the attracting magnetic interaction with the magnet 30. The magnetic interaction is caused by bringing the magnet 30 into spatial proximity to the latch 26 which acts as an opposite pole. To this end, the magnet 30 is disposed on the rotary knob bottom 22d in such a manner that it is moved along the perimeter of the timer 22 while the infusion time is running and is in spatial proximity to the latch 26 when the timer 22 is in a zero position. In this arrangement, the interaction between magnet and latch is attracting.

The latch 26 is encompassed by a frame with a frame top 36 a and a frame bottom 36b. The frame, in the case shown the frame bottom 36b, also serves as a contact point of the spring 24. The strainer lid 16b also serves as a contact point for the spring.

1. A lifting device for a strainer for preparing extraction beverages, particularly for a tea
strainer,
comprising
a timer,
a spring for generating a lifting force applied to a strainer
a latch, which can be moved between a first latch position and a second latch position, and
a magnet, wherein
the latch keeps the spring tensioned in the first latch position and the latch allows relaxation of the spring in the second latch position
and wherein
the magnet is configured to move the latch by magnetic interaction from the first latch position into the second latch position when the timer is in a zero position.

2. The lifting device according to claim 1, wherein the latch comprises a latch spring, which applies a latch spring force to the latch towards the first latch position.

3. The lifting device according to claim 2, wherein the magnet is a permanent magnet.

4. The lifting device according to claim 3, wherein
the magnet is disposed on the latch, and
the lifting device includes an opposite pole, which is disposed on the timer in such a manner that, in the zero position, the opposite pole is in spatial proximity to the magnet.

5. The lifting device according to claim 3, wherein
the magnet is disposed on the timer, and
the lifting device includes an opposite pole, which is disposed on the latch in such a manner that, in the zero position, the magnet is in spatial proximity to the opposite pole.

6. The lifting device according to claim 4, wherein
the opposite pole and the magnet show an attracting or repelling magnetic interaction as soon as they are in spatial proximity

7. The lifting device according to claim 1, wherein the timer is a mechanical timer.

8. The lifting device according to claim 1, wherein
the magnet is an electromagnet.

9. The lifting device according to claim 8, wherein the electromagnet is configured to generate a magnetic field in a zero position of the timer.

10. The lifting device according to claim 9, wherein
the magnet is disposed on the timer, and
the lifting device includes an opposite pole, which is disposed on the latch in such a manner that the opposite pole and the magnet show an attracting or repelling magnetic interaction as soon as the magnet generates a magnetic field.

11. The lifting device according to claim 9,
wherein the timer is an electronic timer.

12. The lifting device according to claim 1, wherein the lifting device includes a trigger device, which is adapted to move the latch from the first latch position into the second latch position, whether the timer is in zero position or not.

13. A device for preparing extraction beverages, particularly a tea maker, comprising a housing, which encloses a space for receiving water, a strainer, which can be moved between a first strainer position, in which the strainer is located inside the space, and a second strainer position, and a lifting device according to any one of the preceding claims, wherein said lifting device keeps the strainer in the first strainer position in the first latch position and allows movement of the strainer into the second strainer position in the second latch position.
